(19) United States
(12) Patent Application Publication
(10) Pub. No.: US 2004/0062869 A1
(43) Pub. Date: Apr. 1, 2004

(54) Waterborne lubricant and method for treating metal surfaces

(76) Inventors: Ryosuke Kawagoshi, Suzumenomiya (JP); Masaaki Fuji, Hiratsuka-shi (JP); Masayuki Yoshida, Atsugi-shi, Kanagawa-Pref. (JP)

Correspondence Address: HENKEL CORPORATION, THE TRIAD, SUITE 200, 2200 RENAISSANCE BLVD., GULPH MILLS, PA, 19406, US

(21) Appl. No.: 10/312,288

(22) PCT Filed: Jun. 28, 2001
(86) PCT No.: PCT/US01/20637

(30) Foreign Application Priority Data
Jun. 28, 2000 (JP) 2000/194377

(51) Int. Cl. B05D 3/02; C10M 173/02

(52) U.S. Cl. 427/372.2; 508/167; 508/465

(57) ABSTRACT

A waterborne lubricant is provided that can form coatings on metal surfaces, inexpensively and with little environmental pollution load, wherein said coatings exhibit very good sliding properties. Also, a surface treatment method that uses the novel waterborne lubricant is provided. The waterborne lubricant contains molybdenum disulfide and waterborne resin having specified characteristics.

### BACKGROUND OF THE INVENTION

1. Field of the Invention

This invention relates to a waterborne lubricant for use for the formation on metal surfaces of coatings that exhibit an excellent sliding lubrication performance. The invention also relates to a surface treatment method that uses said waterborne lubricant. More particularly, the invention relates to a waterborne lubricant comprising molybdenum disulfide and a resin that has particular features and to a method for treating metal surfaces using said waterborne lubricant.

2. Description of the Related Art

Molybdenum disulfide has long been used as a solid lubricant, and even at present it is still used in a variety of applications, most notably for various automotive components. This lubricant has typically been employed by dissolving it and polyamideimide (binder) in an organic solvent, applying the resulting solution by spraying, and thereafter baking. However, given contemporary concerns with global environmental protection, a strong desire has arisen in recent years for development of a waterborne lubricant that would dispense with the use of organic solvent.

Manganese phosphate treatment, on the other hand, became a practical reality in the 1940s with its use as an antirust treatment for steel. Manganese phosphate coatings later entered into use as coatings for sliding applications. This occurred because manganese phosphate coatings are harder than other conversion coatings, exhibit an excellent wear resistance, have a good initial run-in behavior, and, since they are porous, can endow a material with the ability to retain lubricating oil (lubricating oil retained at the surface). In addition, it is thought that metal-to-metal contact occurs in the case of sliding parts that lack a surface treatment, which results in locally high temperatures and high pressures. Severe wear is produced locally during sliding under such circumstances, causing deterioration of the member. Thus, preventing direct metal-to-metal contact is also a crucial consideration. The formation of a manganese phosphate surface coating was discovered to be effective for inhibiting this direct metal-to-metal contact, and coatings of this type have in fact come to be frequently used on sliding parts. This notwithstanding, the requirements imposed by the conditions under which sliding members are used, for example, the load requirements, have over the last few years become more severe in many cases, while longer service lives for sliding members are also desired. These trends have in many instances prevented the simple manganese phosphate coatings of the prior art from exhibiting an adequate performance.

Overcoating molybdenum disulfide on manganese phosphate has been one strategy contemplated for improving the tribological properties of the coating. For example, Japanese Published (Kokoku or Examined) Patent Application No. Hei 7-113401 (113,401/1995), entitled “Geared transmission mechanism for vacuum ambients”, discloses a geared transmission mechanism for vacuum ambients in which at least the intermeshing regions of the teeth are formed of alloy tool steel and solid lubricated teeth are provided by the formation in said intermeshing regions of a manganese phosphate undertreatment layer and then a solid lubricating film. While this patent application states that the solid lubricating film is preferably formed of molybdenum disulfide, it provides no description whatever of the binder for the lubricant that forms the solid lubricating layer. An antiwear member is described in Japanese Laid Open (Kokai or Unexamined) Patent Application No. Hei 9-184079 (184,079/1997). To give the antiwear member disclosed therein, a 3 0 manganese phosphate layer is provided on at least the upper and lower surfaces of the body of a compression ring. A lubrication layer is also provided comprising a dispersion of molybdenum disulfide with an average particle size of 1-2 μm in the gaps between the crystal grains of the manganese disulfide. Preferred for use as the binder in the disclosed method are polyamideimide, epoxy, polyimide, and polytetrafluoroethylene; however, no mention is made of the mechanical properties of these resins. Polyamideimide is used as the binder in the examples, and presumably application is carried out from an organic solvent system.

### SUMMARY OF THE INVENTION

This invention seeks to remedy the problems delineated above for the prior art. More specifically, an object of this invention is to provide a novel waterborne lubricant that can form coatings on metal surfaces, inexpensively and with little environmental pollution load, wherein said coatings exhibit very good sliding properties. An additional object of this invention is to provide a surface treatment method that uses the novel waterborne lubricant.

The inventors carried out extensive investigations into means for solving the problems that encumber the prior art as described above. As a result of these investigations, the inventors discovered a waterborne lubricant comprising molybdenum disulfide with a particular particle size and resin with particular mechanical properties, and also discovered a surface treatment method that uses this lubricant. The inventors additionally discovered a method for forming a special composite coating that comprises a manganese phosphate coating layer and a lubricating layer. This invention was achieved based on these discoveries.

More specifically, this invention relates to a waterborne lubricant that characteristically comprises molybdenum disulfide having an average particle diameter of 0.5 to 10 μm and a waterborne resin that has a weight average molecular weight of 5,000 to 50,000, a rupture strength of at least 300 kg/cm², and a rupture elongation no greater than 10%. The waterborne resin is preferably a polyester resin or waterborne urethane resin. This invention also relates to a method for treating metal surfaces that characteristically comprises.

(a) effecting contact between the inventive lubricant and a clean metal surface in order to form thereon a coating layer of the waterborne lubricant wherein said coating layer contains molybdenum disulfide at 0.1 to 5.0 g/m² as molybdenum and resin at 0.1 to 5.0 g/m ² as carbon; and

(b) thereafter drying the waterborne lubricant coating layer by baking at 100 to 250° C.

This invention further relates to a method for treating metal surfaces that characteristically comprises:

(a) effecting contact between the inventive lubricant and a metal surface that is coated with a crystalline manganese phosphate coating having a coating thickness of 1 to 15 μm, a crystal diameter of 0.5 to 30 μm, and a surface roughness (Rz) of 0.5 to 20 μm, in order to form a coating layer of the waterborne lubricant wherein said coating layer contains molybdenum disulfide at 0.1 to 5.0 g/m² as molybdenum and resin at 0.1 to 5.0 g/m² as carbon; and

(b) thereafter drying the waterborne lubricant coating layer by baking at 100 to 250° C. in order to form a composite coating comprising a manganese phosphate coating layer and a lubricant coating layer.

### DETAILED DESCRIPTION OF THE INVENTION

This invention will be explained in greater detail hereinbelow.

There are no particular restrictions on the metals to which this invention may be applied, but the invention will be used mainly on aluminum, aluminum alloys, and steels such as carbon steel, chromium steel, chromium-molybdenum steel, and high-carbon chromium steel.

The inventive waterborne lubricant can be prepared by dispersing molybdenum disulfide and waterborne resin in water. The molybdenum disulfide used in the inventive waterborne lubricant should have an average particle size in the range of 0.5 to 10 μm: excellent sliding properties are obtained by the use of molybdenum disulfide in this range. Particle sizes smaller than 0.5 μm are not problematic with regard to properties or performance, but are disadvantageous due to the associated high cost. At the other end of the range, particles greater than 10 μm are usually poorly dispersible in the lubricant. The waterborne resin used in the inventive waterborne lubricant is a resin that can be used when dissolved or dispersed in water. This resin can be exemplified by polyester resins, polyurethane resins, and polyphenol resins with polyester resins and waterborne urethane resins (dispersions) being preferred. The polyester resin can be, for example, polyester resin synthesized using a sulfonated terephthalic acid or isophthalic acid in the copolymerization components. The urethane resin can be, for example, waterborne polyurethane resin based on a polyol such as a polyether polyol or polyester polyol and polyisocyanate such as tolidine diisocyanate or tolylene diisocyanate. Resin should be used that has a rupture strength of at least 300 kg/cm², an elongation at rupture no greater than 10%, and a weight average molecular weight of 5,000 to 50,000. An excellent antiwear behavior is obtained using resin with a high rupture strength and low elongation. The average molecular weight should be in the stated range due to its influence on the dispersibility of the treatment agent.

The method for treating metal surfaces using the inventive waterborne lubricant will now be explained. The subject method for treating metal surfaces begins with effecting contact between the inventive waterborne lubricant and a clean metal surface in order to induce the formation thereon of a coating layer of the waterborne lubricant that contains molybdenum disulfide (preferably at 0.1 to 5.0 g/m² as molybdenum) and resin (preferably at 0.1 to 5.0 g/m² as carbon). This is followed by drying by baking at an elevated temperature, for example 100 to 250° C. This baking produces on the metal surface a lubricating coating preferably containing 0.1 to 5.0 g/m² as molybdenum and 0.1 to 5.0 g/m² as carbon. Satisfactory sliding properties are not obtained when the post-baking/drying deposition of molybdenum or carbon is less than 0.1 g/m². A molybdenum or carbon deposition in excess of 5.0 g/m² poses no particular problems but is economically disadvantageous.

The procedure for effecting contact between the waterborne lubricant and metal is not critical, and immersion, spray application, and so forth can be used. Contact can be carried out using a concentrate of the waterborne lubricant or using the diluted treatment bath. Surfactant may also be used in order to induce uniform application of the molybdenum disulfide. The concentrations of the molybdenum disulfide and resin in the treatment bath are not critical, but a concentration of about 0.1 to 1% by weight is normally preferred for each component. At low concentrations below 0.1%, the specified deposition cannot be obtained without repeating application a number of times, which lengthens the process and is economically disadvantageous. The use of concentrations in excess of 1% is disadvantageous because such concentrations lead to a deterioration in the stability of the treatment bath.

Contact may be followed by baking/drying at 100 to 250° C. in order to form a lubricating coating layer. The drying temperature should be in this range since the goals of baking/drying are to eliminate the water, to cause the resin used to flow (i.e., to soften and thereby smooth out the resin), and to obtain a higher level of adhesion. The range of 150 to 200° C. is even more preferred.

When the foregoing metal surface treatment method is to be executed on steel, the formation of a manganese phosphate coating on the metal surface in advance of lubricant deposition is preferred based on such considerations as the sliding lubrication performance, adherence, and corrosion resistance. The manganese phosphate coating formed in this case is preferably controlled within the following ranges: coating thickness=1 to 15 μm, crystal size=0.5 to 30 μm, and surface roughness (Rz)=0.5 to 20 μm. The seizing load declines at a coating thickness below 1 μm, while coating thicknesses in excess of 15 μm generally afford no additional change in the properties and are uneconomical. With respect to the crystal size, the load resistance is typically unacceptable at below 0.5 μm, while the coefficient of friction (COF) usually becomes undesirably high at values in excess of 30 μm. A surface roughness (Rz) below 0.5 μm is normally undesirable due to the low adherence that occurs at such values. At a surface roughness (Rz) in excess of 20 μm the roughness of the surface becomes so large that the coverage performance of the lubricating coating often is degraded.

The methods used to measure the coating thickness, crystal size, surface roughness, molybdenum deposition, and carbon deposition specified by this invention will now be considered. The coating thickness of the manganese phosphate coating was measured by cutting the member after conversion treatment and inspecting the cross section with a metallographic microscope. The crystal size was measured by inspection of the surface using a commercial scanning electron microscope (SEM), while the surface roughness was measured using a commercial surface roughness meter.

The molybdenum deposition was determined using a commercial fluorescent X-ray analyzer (XRF). A working curve of intensity-versus-amount of deposition was constructed by carrying out multiple measurements on samples having known, different amounts of molybdenum deposition. Using the same conditions as used to obtain the working curve data, the sample afforded by the inventive surface treatment method was then cut into a sample of suitable size (diameter about 3 cm) on which the actual measurement was carried out. The measured intensity was converted into molybdenum deposition using the working curve. The carbon deposition was measured using a commercial surface carbon analyzer (TOC). The sample was obtained by cutting a sample treated by the inventive surface treatment method to the appropriate size (about 20 to 50 cm²). The sample was heated in the surface carbon analyzer in order to oxidize and thereby volatilize the carbon present on the surface, and the resulting gas was determined using an infrared absorption analyzer (IR). Any measurement conditions may be used that induce oxidation and volatilization of the surface carbon, but preferred measurement conditions are generally about 400° C. for 5 minutes.

### EXAMPLES

Several working examples of this invention are provided below, and the utility of these working examples is illustrated with reference to comparative examples.

Sample Material

Treatment was carried out on the following steels. flat plate: S45C, dimensions=30 mm×80 mm, thickness=1 mm sliding lubrication test piece (SRV): SUJ2 Ø24×8 mm

Pretreatment

Cleaning: Cleaning was carried out by dipping for 3 minutes at 60° C. in a 2% aqueous solution of a commercial cleaner (FINECLEANER 4360, registered trademark and product of Nihon Parkerizing Co., Ltd.) followed by a water rinse with tapwater for 30 seconds.

Manganese phosphate treatment: After the cleaning step, the material was dipped first in the 0.3% aqueous solution of a commercial surface conditioner (PREPALENE 55 in Example 3 and PREPALENE VM in Example 4 and Comparative Example 2, both registered trademarks and products of Nihon Parkerizing Co., Ltd.) and was then dipped for 5 minutes at 95° C. in a 15% aqueous solution of a commercial manganese phosphate conversion agent (PALPHOS M1A, registered trademark and product of Nihon Parkerizing Co., Ltd.). Conversion treatment was followed by a water rinse and drying.

### Example 1

The cleaned steel sample was first coated with surface treatment bath 1 as described below and was then baked for 10 minutes at 160° C.

Surface Treatment Bath 1

| | |
|---|---|
| molybdenum disulfide: | average particle size = 2.0 μm |
| waterborne resin: | polyester resin |
| resin rupture strength: | 350 kg/cm² |
| resin elongation: | 2% |
| weight average molecular | 10,000 |
| weight of the resin: | |

Treatment bath 1 was prepared by dispersing the molybdenum disulfide particles in an aqueous dispersion of the polyester resin.

### Example 2

The cleaned steel sample was first coated with surface treatment bath 2 as described below and was then baked for 10 minutes at 200° C.

Surface Treatment Bath 2

| | |
|---|---|
| molybdenum disulfide | 4.0 μm |
| (average particle size): | |
| waterborne resin: | polyester resin |
| resin rupture strength: | 320 kg/cm² |
| resin elongation: | 1% |
| weight average molecular | 12,000 |
| weight of the resin: | |

Treatment bath 2 was prepared by dispersing the molybdenum disulfide particles in an aqueous dispersion of the polyester resin.

### Example 3

The cleaned steel sample was subjected to the manganese phosphate treatment described above, then coated with surface treatment bath 3, and finally baked for 5 minutes at 220° C.

Surface Treatment Bath 3

| | |
|---|---|
| molybdenum disulfide | 20 μm |
| (average particle size): | |
| waterborne resin: | waterborne urethane resin |
| resin rupture strength: | 310 kg/cm² |
| resin elongation: | 5% |
| weight average molecular | 8,000 |
| weight of the resin: | |

Treatment bath 3 was prepared by dispersing the molybdenum disulfide particles in an aqueous dispersion of the urethane resin.

### Example 4

The cleaned steel sample was immersed for 10 minutes in surface treatment bath 4 (heated to 65° C.) and then washed with water and dried. This was followed by coating with the surface treatment bath 3 described in Example 3 and baking for 10 minutes at 180° C.

Surface Treatment Bath 4

| | |
|---|---|
| molybdenum disulfide | 15 μm |
| (average particle size): | |
| waterborne resin: | waterborne urethane resin |
| resin rupture strength: | 350 kg/cm² |
| resin elongation: | 3% |
| weight average molecular | 15,000 |
| weight of the resin: | |

Treatment bath 4 was prepared by dispersing the molybdenum disulfide particles in an aqueous dispersion of the urethane resin.

### Comparative Example 1

Only the above-described cleaning step was carried out; the otherwise ensuing surface treatment was not done.

### Comparative Example 2

Only the above-described cleaning step and manganese phosphate treatment were carried out; the otherwise ensuing surface treatment was not done.

Table 1 reports the following values for Examples 1 through 4 and Comparative Examples 1 and 2: coating thickness, particle size, and roughness of the manganese phosphate layer; amount of molybdenum and amount of carbon in the lubricating coating layer formed by surface treatment; and an evaluation of the sliding lubrication. The sliding lubrication test was carried out using the following method.

Sliding Lubrication Test

This evaluation was carried out using a commercial SRV test instrument. Using the combination of a treated test piece and an untreated steel ball (SUJ2, diameter=10 mm), sliding was carried out in the absence of an oil coating using a load of 100 N, a stroke frequency of 50 Hz, and a stroke amplitude of 2 mm. The COF and the time required to reach a COF of 0.6 were measured. In the configuration under consideration, longer times correspond to a better lubricating performance.

The results in Table 1 confirm that execution of this invention afforded an excellent lubricating performance.

TABLE 1

| | manganese phosphate | | | | | evaluation |
|---|---|---|---|---|---|---|
| | coating layer | | | | | of sliding |
| | coating | parti- | | lubricating | | lubrication |
| | thick- | cle | rough- | coating layer | | SRV sliding |
| | ness | size | ness | Mo | C | time |
| | (μm) | (μm) | Rz (μm) | (g/m²) | (g/m²) | (seconds) |
| Example 1 | — | — | — | 1.5 | 1.5 | 200 |
| Example 2 | — | — | — | 2.0 | 2.0 | 200 |
| Example 3 | 3 | 2 | 1.5 | 3.0 | 3.0 | 300 |
| Example 4 | 10 | 20 | 8 | 4.0 | 4.0 | 300 |
| Comp. Ex. 1 | 0 | 0 | — | 0 | 0 | 5 |
| Comp. Ex. 2 | 10 | 20 | 8 | 0 | 0 | 25 |

The present invention accrues the highly desirable effects of providing metal surfaces with a coating that exhibits a very good sliding lubrication performance and of doing so at low cost and with a low environmental pollution load. The invention achieves these effects by formulating a waterborne lubricant using a special waterborne resin and using this waterborne lubricant to treat metal surfaces.

What is claimed is:

1. A waterborne lubricant comprising:
(a) molybdenum disulfide having an average particle diameter of 0.5 to 10 μm; and
(b) a waterborne resin having a weight average molecular weight of 5,000 to 50,000, a rupture strength of at least 300 kg/cm² , and a rupture elongation no greater than 10%.

2. The waterborne lubricant of claim 1 wherein the waterborne resin is selected from the group consisting of polyester resins and urethane resins.

3. The waterborne lubricant of claim 1 or 2 wherein molybdenum disulfide is present at a concentration of 0.1 to 1% by weight.

4. The waterborne lubricant of claim 1, 2 or 3 wherein the waterborne resin is present at a concentration of 0.1 to 1% by weight.

5. A method for treating a metal surface comprising:
(a) contacting the waterborne lubricant of claim 1, 2, 3 or 4 with a metal surface in order to form thereon a coating layer of the waterborne lubricant; and
(b) drying the coating layer of the waterborne lubricant.

6. The method of claim 5 wherein the metal surface is cleaned prior to step (a).

7. The method of claim 5 or 6 wherein the metal surface is coated with a crystalline manganese phosphate coating prior to step (a).

8. The method of claim 7 wherein the crystalline manganese phosphate coating has a coating thickness of 1 to 15 μm, a crystal diameter of 0.5 to 30 μm, and a surface roughness (Rz) of 0.5 to 20 μm.

9. The method of claim 5, 6, 7, or 8 wherein said coating layer contains molybdenum disulfide at 0.1 to 5.0 g/m² as molybdenum and resin at 0.1 to 5.0 g/m² as carbon.

10. The method of claim 5, 6, 7, 8 or 9 wherein said drying is accomplished by baking at 100 to 250° C.

11. A coated metal surface produced by the method of claim 5, 6, 7, 8 or 9.
